(19) United States
(12) Patent Application Publication
(10) Pub. No.: US 2023/0360552 A1
(43) Pub. Date: Nov. 9, 2023

(54) METHOD, APPARATUS, DEVICE AND MEDIUM FOR INFORMATION UPDATING

(71) Applicant: Beijing Youzhuju Network Technology Co., Ltd., Beijing (CN)

(72) Inventors: Shujun Deng, Beijing (CN); Lei Zhou, Beijing (CN); Wenyu Nie, Beijing (CN); Weican Ma, Beijing (CN)

(21) Appl. No.: 18/300,990

(22) Filed: Apr. 14, 2023

(30) Foreign Application Priority Data
May 5, 2022 (CN) 202210483864.8

(51) Int. Cl. G09B 7/00

(52) U.S. Cl. CPC G09B 7/00

(57) ABSTRACT

According to the embodiments of the present disclosure, a method, an apparatus, a device, and a storage medium for information updating are provided. The method for information updating comprises obtaining a response result of a target object to a target item, the response result indicating a successful or a failure response of the target object to the target item. The method also comprises determining a capability update amount for the target object based on capability information of the target object, attribute information of the target item, and the response result; and updating the capability information of the target object based on the capability update amount, to obtain updated capability information of the target object.

### CROSS-REFERENCE TO RELATED APPLICATIONS

The present application claims priority to Chinese Patent Application No. 202210483864.8, titled “METHOD, APPARATUS, DEVICE AND MEDIUM FOR INFORMATION UPDATING,” filed on May 5, 2022, the contents of which are hereby incorporated by reference in its entirety.

### TECHNICAL FIELD

Example embodiments of the present disclosure generally relate to the field of computers, and in particular to a method, an apparatus, a device, and a computer-readable storage medium for information updating.

### BACKGROUND

IRT (Item Response Theory), also known as Latent Trait Theory, Strong True Score Theory, and Modern Mental Test Theory, is mainly used in the field of education and psychological measurement to measure capability of a testee and relevant attributes of the test question (such as difficulty, discrimination, etc.). Among them, the so-called “item” refers to content for which a target object is assessed (for example, a test question answered in the field of education), and “item response” refers to a response result (for example, right and wrong) of the target object (for example, the testee) on the specific assessed content (for example, the test question). In addition to education and psychology, IRT is also increasingly applied to many other fields, such as information recommendation, event analysis, and the like.

In IRT-related analysis, it is necessary to consider relevant information of objects and items, including capability information of the object and attribute information of the items. The accurate determination of such information is an important basis for the IRT analysis.

### SUMMARY

According to example embodiments of the present disclosure, a solution for information updating is provided.

In a first aspect of the present disclosure, a method for information updating is provided. The method comprises obtaining a response result of a target object to a target item, the response result indicating a successful response or a failure response of the target object to the target item; determining a capability update amount for the target object based on capability information of the target object, attribute information of the target item, and the response result; and updating the capability information of the target object based on the capability update amount, to obtain updated capability information of the target object.

In a second aspect of the present disclosure, an apparatus for information updating is provided. The apparatus comprises an obtaining module configured to obtain a response result of a target object to a target item. The response result indicates a successful response or a failure response of the target object to the target item; a determining module configured to determine a capability update amount for the target object based on the capability information of the target object. The attribute information of the target item and the response result; and an updating module configured to update the capability information of the target object based on the capability update amount, to obtain updated capability information of the target object.

In a third aspect of the present disclosure, an electronic device is provided. The device comprises at least one processing unit; and at least one memory coupled to the at least one processing unit and storing instructions executable by the at least one processing unit, the instructions, when executed by the at least one processing unit, causing the device to perform the method of the first aspect.

In a fourth aspect of the present disclosure, a computer-readable storage medium is provided. The medium has a computer program stored thereon which, when executed by a processor, performs the method of the first aspect.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 shows a schematic diagram of an example environment in which the embodiments of the present disclosure can be applied;

FIG. 2 shows a schematic block diagram of a dynamic updating system according to some embodiments of the present disclosure;

FIG. 3 shows a flowchart of a process of capability information updating according to some embodiments of the present disclosure;

FIG. 4 shows a flowchart of a process of attribute information updating according to some embodiments of the present disclosure;

FIG. 5 shows a schematic diagram of the application of the dynamic updating system according to some embodiments of the present disclosure;

FIG. 6 shows a block diagram of an apparatus for information updating according to some embodiments of the present disclosure; and

FIG. 7 shows a block diagram of a device capable of implementing multiple embodiments of the present disclosure.

### DETAILED DESCRIPTION

The embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

It is understandable that the data involved in this technical proposal (including but not limited to the data itself, data acquisition or use) shall comply with the requirements of corresponding laws, regulations and relevant provisions.

It is understandable that before using the technical solution disclosed in each embodiments of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users can select whether to provide personal information to the software or the hardware such as an electronic device, an application, a server or a storage medium that perform the operation of the technical solution of the present disclosure according to the prompt information.

As an optional but non-restrictive implementation method, in response to receiving the user's active request, the method of sending prompt information to the user can be, for example, a pop-up window in which prompt information can be presented in text. In addition, pop-up windows can also contain selection controls for users to choose “agree” or “disagree” to provide personal information to electronic devices.

It can be understood that the above notification and acquisition of user authorization process are only schematic and do not limit the implementation methods of the present disclosure. Other methods that meet relevant laws and regulations can also be applied to the implementation of the present disclosure.

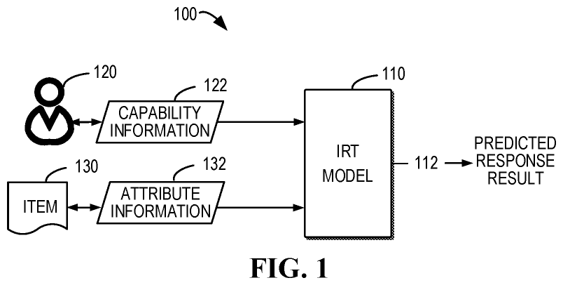

FIG. 1 shows a schematic diagram of an example environment 100 in which the embodiments of the present disclosure can be implemented. In this example environment 100, an IRT model 110 is provided which is configured to determine a predicted response result 112 of an object 120 to an item 130. The input of the IRT model 110 includes capability information 122 of the object 120 and attribute information 132 of the item 130. The predicted response result 112 output by the IRT model 110 may indicate the probability of a successful response or a failure response of the object 120 to the item 130.

The IRT model 110 is based on IRT and is built for different application scenarios. As a specific example, in an educational or psychological test scenario, the item 130 includes a test question covering one or some knowledge points, and the object 120 includes a testee who answers the test question. The objective of the IRT model 110 is to determine the probability that the testee answers a specific question correctly (or incorrectly).

In such an educational or psychological test scenario, the capability information 122 of the object 120 may indicate a knowledge mastery level of the object 120. The higher the capability level may indicate the higher the knowledge mastery level of the object 120. The attribute information 132 of the item 130 may be represented by one or more attribute parameters, including the difficulty, the discrimination and/or the correct probability in pseudo-guessing of the item 130. The greater the value of discrimination of the item represents the higher the degree of discrimination of the item to the testee. The higher the value of the correct probability in guessing of the item illustrates the easier it is to guess, regardless of the capability of the testee. In addition to educational or psychological test scenarios, the IRT model 110 may also be set for other scenarios.

IRT may be modeled by various types of models, including a logistic model, a normal ogive model, etc. Different types of models have models of different parameter numbers (for example, different attributes for the item), including a single-parameter model (also known as a Rasch model, the item attribute only has difficulty), a two-parameter model (the test question attribute includes difficulty and discrimination), and a three-parameter model (the test question attribute includes difficulty, discrimination, and correct probability in pseudo-guessing).

Below are some example models that may be applied in the IRT model 110. In some examples, the IRT model 110 may be constructed based on the normal ogive model. In some examples, because the form of integral function is adopted in the normal ogive model, it is not convenient in practical use and may be transformed into a Logistic form of model.

In some examples, the IRT model 110 may be constructed as a Logistic single-parameter model, which may be expressed by the following equation:

$$P ( θ ) = \frac{1}{1 + {e}^{- ( θ - b )}} \qquad ( 1 )$$

In some examples, the IRT model 110 may be constructed as a Logistic two-parameter model, which may be expressed by the following equation:

$$P ( θ ) = \frac{1}{1 + {e}^{- ( a ) ( θ - b )}} \qquad ( 2 )$$

In some examples, the IRT model 110 may be constructed as a Logistic three-parameter model, which may be expressed by the following equation:

$$P ( θ ) = c + \frac{1 - c}{1 + {e}^{- a ( θ - b )}} \qquad ( 3 )$$

In the above Equations (1) to (3), θ represents the overall capability of the object, a represents the discrimination of the item, b represents the difficulty of the item, c represents the correct probability in guessing of the item, and P(θ) represents the probability of the successful response of the object with the capability θ to the item. θ, a, b and c may have their own value ranges, which may be set according to the applications.

The various types of the IRT models 110 may be expressed as P (x=1 |θ, a, b, c), wherein x=1 represents the successful response of the object to the item. If the discrimination a=1 and the correct probability in pseudo-guessing c=0, then the IRT model 110 is expressed as a single-parameter model. If the correct probability in pseudo-guessing is c=0, then the IRT model 110 is represented as a two-parameter model.

In some embodiments, the IRT model 110 may also be represented by a cumulative distribution function (CDF) of a standard normal distribution. For example, the IRT model 110 based on the single-parameter model may be represented as:

P(x=1|θ,b)=Φ(θ−b)

Φ ( ) represents a CDF function of a standard normal distribution. The two-parameter and three-parameter models may also be similarly represented.

It would be appreciated that the above description is only some examples of the IRT model 110. The IRT model 110 may also have other variations, and the embodiments of the present disclosure may also be used in combination.

In addition to the IRT model to determine the probability of a specific object's response to the success or failure of the item, the capability information of the object and various attribute information of the item based on the IRT theory may also be applied to various other analysis applications. For example, by analyzing the capability information of a specific object or a group of objects, it is helpful to specify a follow-up strategy for the target object group, including a target item classification strategy, an education strategy, a test strategy, etc. By measuring various attribute information of an item and capability information of an object, more matching items may be pushed to the target object, etc. It can be seen that the estimation of these parameter information in the IRT is the premise of applying the IRT.

In general, the parameters are estimated by using the commonly used maximum likelihood estimation and Bayesian method. The existing parameter estimation process is not real-time, and usually needs to collect the response result of a large number of objects to a specific item, and determine the update through a statistical method. Therefore, it is often necessary to update parameters in a certain period (for example, at the level of one day or several days). However, such an update cycle may not be appropriate in many scenarios. For example, in the educational or psychological test scenario, after the user completes a test question and completes relevant learning (for example, watching video explanation), the corresponding capability of the user will change. Based on the original capability information, it may not be able to plan the user's next learning content better and timelier. Therefore, it is expected to provide a dynamic and real-time information update solution in the IRT.

According to the embodiments of the present disclosure, a dynamic information update solution is provided. In this solution, after the target object completes the response to the target item, the capability update amount for the target object is determined based on the response result, the capability information of the target object and the attribute information of the target item. Update the capability information of the target object based on the capability update amount to obtain the updated capability information of the target object. According to the solution of the present disclosure, the capability information of the object may be updated iteratively as the object responds to different items, to reflect the real-time capability of the object more accurately. The accurate and real-time capability information of the object can be used for more accurate analysis in IRT-related applications.

In some embodiments, the attribute update amount for the target item may also be determined based on the response result, the capability information of the target object, and the attribute information of the target item to update the attribute information of the target item. In this way, the attribute information of the item may be updated iteratively with the response of different objects to a specific item, to reflect the attribute of the item more accurately. Accurate attribute information also contributes to more accurate analysis in IRT-related applications.

The following will continue to describe some example embodiments of the present disclosure with reference to the accompanying drawings.

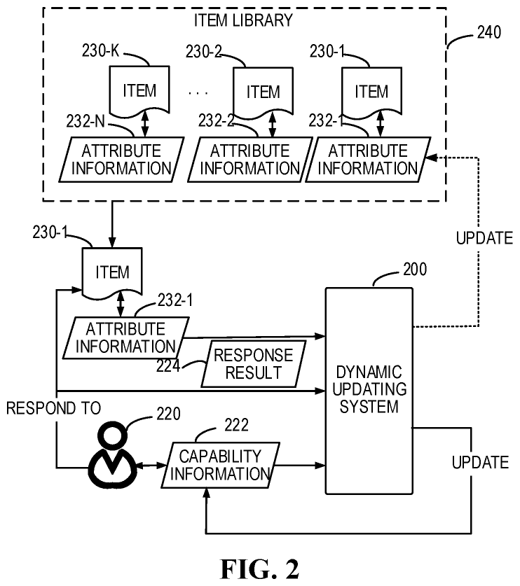

FIG. 2 shows a schematic block diagram of a dynamic updating system 200 according to some embodiments of the present disclosure. As shown in FIG. 2, the target object 220 responds to the item in the item library 240, and the response result indicates the target object 220's successful or failure response to a specific item. The item library 240 includes one or more items 230-1, 230-2, . . . , 230-K. For the convenience of discussion, these items are collectively or individually referred to as an item 230 in this article, wherein K is an integer greater than or equal to 1). In the example of FIG. 2, as an example, it is assumed that the item 230-1 in the item library 240 is provided to the target object 220 to execute the response, and the response result 224 is generated. Here, the item 230-1 is called the target item.

Each item 230 has corresponding attribute information, for example, the item 230-1 has attribute information 232-1, the item 230-2 has attribute information 232-2, . . . , and the item 230-K has attribute information 232-K. For the convenience of discussion, these attribute information are collectively or individually referred to as attribute information 232. In addition, the target object 220 has corresponding capability information 222.

In the educational or psychological test scenario, the item 230 may include a test question covering one or some knowledge points, and the target object 220 may include the testee who answers the questions. The response of the target object 220 to the item 230 includes the testee's answer to the question. Accordingly, the successful response indicates that the testee answers the question correctly, and the failure response indicates that the testee cannot answer the question correctly.

In some embodiments, in the educational or psychological test scenario, the capability information 222 of the target object 220 may at least indicate the overall capability of the target object 220 to reflect the overall mastery level of the target object 220 to a certain knowledge field. In some embodiments, in such a scenario, the attribute information 232 of the item 230 may indicate the difficulty of the test question. In some embodiments, the attribute information 232 of item 230 may additionally or alternatively indicate the discrimination of the test question. In some embodiments, attribute information 232 of the item 230 may additionally or alternatively indicate the correct probability in pseudo-guessing. In some examples, the difficulty may have a value in a continuous range of difficulty values, or it may be one of several discrete difficulty levels. Similarly, the discrimination and the correct probability in pseudo-guessing may also have values in the range of continuous values, or may be a certain level in multiple discrete levels.

In some embodiments, the IRT theory may also be applied to an information recommendation scenario. In the information recommendation scenario, the item 230 may include a recommendation item, such as a product to be recommended, an advertising link, an application, other types of information, etc. Accordingly, the target object 220 includes a recommended object, such as a user. The response of the target object 220 to the item 230 may indicate whether the recommendation item was successfully recommended to the user, that is, whether the conversion of the recommendation item to the recommended object was successful. Here, a “successful recommendation” of the recommendation item may have different measurement standards according to the actual application. For example, the “successful recommendation” may include users clicking on an advertising link, purchasing or browsing a product, downloading or registering an application, etc.

In some embodiments, in the information recommendation scenario, the capability information 222 of the target object 220 may at least indicate the successful conversion capability of the recommendation item to the recommended object, that is, whether the target object 220 has a strong desire to select the recommendation item. In some embodiments, the attribute information 232 of item 230 may indicate the difficulty of selecting the recommendation item. In some embodiments, in the information recommendation scenario, other attribute parameters of the recommendation item may also be defined to indicate the relevant characteristics of the recommendation item. In this regard, the embodiments of the present disclosure are not limited.

In some embodiments, the IRT theory may also be applied to competition analysis, including a game competition, a sports competition, etc. In the competition analysis scenario, the target object 220 may include a participating team or a team member, and the item 230 may include a competitor. The response of the target object 220 to the item 230 includes a competition between the participating team or the team member and the competitor. Accordingly, the successful response indicates that the team or the team member can defeat the opponent, while the failure response indicates that the team or the team member cannot defeat the opponent.

In the competition analysis scenario, the capability information 222 of the target object 220 may at least indicate the overall capability of the target object 220 to reflect the overall capability of a corresponding competitive event. In some embodiments, in such a scenario, the attribute information 232 of the item 230 may indicate the overall capability of a competitor in a corresponding competitive event. In some embodiments, in the competition analysis scenario, other attribute parameters of competitors may also be defined to indicate the relevant characteristics of the recommendation item. In this regard, the embodiments of the present disclosure are not limited.

It would be appreciated that some scenarios of applying the IRT theory are given above. The IRT theory may also be applied to other scenarios, and in those scenarios, the target object 220 and the item 230 may have different indications. The embodiments of the present disclosure are not limited in this regard. In some of the following example embodiments, for the convenience of discussion, the educational or the psychological test scenario is mainly explained, but it would be appreciated that this does not imply that those embodiments can only be applied to these scenarios.

In some embodiments, when measuring the capability of the object, in addition to considering the overall capability, a finer measurement branch in the corresponding scenario for the item may be considered. Specifically, in order to measure the capability of an object, an item hierarchy may be constructed, which includes multiple hierarchical levels for measuring the capability of the object. Each hierarchical level may have one or more measurement branches.

For example, for an educational or a psychological testing scenario, the item hierarchy may include a knowledge structure of a discipline, wherein different hierarchical levels include different knowledge hierarchical levels in the knowledge structure, and each hierarchical level has one or more knowledge points (that is, the measurement branch). For another detailed example, in mathematics, the first hierarchical level may include the knowledge point of an equation set, a trigonometric function, etc. Further, the knowledge point of the first hierarchical level of the equation set may also include one or more knowledge points of lower hierarchical level (for example, the second hierarchical level), such as a linear equation with one unknown, linear equations of two unknown, etc.

Different test questions may involve the examination of different knowledge points. For example, a test question may evaluate a single knowledge point at the first hierarchical level, such as a set of equations, and may cover one or more knowledge points at the second hierarchical level. When assessing the testee's mastery capability to the discipline, in addition to giving the overall capability of the testee, it is also necessary to measure the testee's mastery capability to the knowledge point of the first hierarchical level, or more precisely, the testee's mastery capability to each knowledge point of the second hierarchical level.

For another example, for the competition analysis scenario, the item hierarchy may include a competitive structure of a certain competition, wherein different hierarchical levels include different competitive items in the competitive structure, which are divided by the hierarchical level. For example, in an electronic game, the first hierarchical level may include multiple game tasks, and the game tasks in the first hierarchical level may also include a smaller subtask in the second hierarchical level. Different competitive items may be used to complete one or more game tasks at different hierarchical levels, that is, each item may involve the examination of one or more branches in the game. Accordingly, when testing the capability of the competition team or the team member, in addition to giving the overall capability, the capability of the competition team in a specific game task or subtask may also be measured.

To sum up, in some embodiments, the capability information 222 of the target object 220 may include the overall capability information of the target object 220, which indicates the overall capability level of the target object at multiple measurement branches at multiple hierarchical levels in the item hierarchy. In addition, the capability information 222 of the target object 220 may also include the local capability information of the target object 220 at each measurement branch at each hierarchical level in the item hierarchy, which indicates the local capability level of the target object 220 on the corresponding measurement branch. That is, the capability of the target object 220 may be composed of the overall capability and the local capability at one or more levels. In the IRT theory considering the overall and the local capability information, a two-factor IRT model may be constructed. The two-factor IRT model will be described in more detail below.

In some embodiments, the capability information 222 of the target object 220 may be indicated by a probability distribution, and the capabilities of different levels may be indicated by the corresponding probability distribution. In some examples, the overall capability information may indicate the probability distribution which is followed by the overall capability level of the target object 220, and the local capability information at each measurement branch in the item hierarchy may indicate the probability distribution which is followed by the local capability level of the target object 220. In some embodiments, the attribute information 232 of the item 230 may also be indicated by the probability distribution.

In some embodiments, it can be assumed that both the capability information 222 and the attribute information 232 follow the normal distribution, which may be represented by a corresponding expectation and a standard deviation (or variance). In addition to the normal distribution, the capability information 222 and the attribute information 232 may also be modeled to follow other probability distributions, which may be selected according to an actual application. Any appropriate probability distribution may be applied to represent the capability information 222 and the attribute information 232.

In the embodiments of the present disclosure, it is proposed to dynamically update the capability information 222 of the target object 220 based on the response result 224 after the target object 220 completes the response to the target item 230-1, instead of waiting for a certain time to update after collecting enough response results of the object.

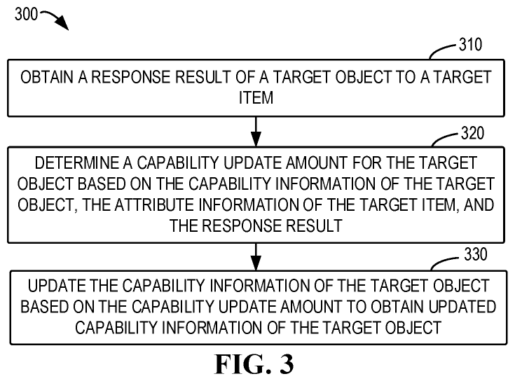

FIG. 3 shows a flowchart of a process 300 of capability information updating according to some embodiments of the present disclosure. Process 300 may be implemented at the dynamic updating system 200.

Specifically, at block 310, the dynamic updating system 200 is configured to obtain a response result 224 of a target object 220 to a target item 230-1, which indicates a successful response or a failure response (for example, correct or wrong answer). In some embodiments, the dynamic updating system 200 may obtain the response result of the target object 220 to the item in real time. For example, in an online education scenario, the answers of the testee to the test question may be collected and recorded in real time and fed back to the dynamic updating system 200. In other embodiments, the response result 224 may also be provided to the dynamic updating system 200 by, for example, manual input or other means.

At block 320, the dynamic updating system 200 determines a capability update amount for the target object 220 based on the capability information 222 of the target object 220, the attribute information 232-1 of the target item 230-1, and the response result 224. Here, the capability information 222 of the target object 220 and the attribute information 232 of each item 230, including the attribute information 232-1 of the target item 230-1, may be maintained. In the embodiments of the present disclosure, the dynamic updating system 200 may determine the capability update amount for the target object 220 based on the IRT theory.

Since the capability information 222 may be updated iteratively in the embodiments of the present disclosure, each time the dynamic updating system 200 may obtain the current capability information 222 of the target object 220. In some embodiments of the present disclosure, if the attribute information 232 of the item 230 is also updated, the dynamic updating system 200 may obtain the current attribute information 232-1 of the target item 230-1. The determination of capability update amount will be discussed in detail below.

At block 330, the dynamic updating system 200 updates the capability information of the target object 220 based on the capability update amount to obtain updated capability information 222 of the target object 220. In the embodiments of the present disclosure, the capability information of the target object is iteratively updated with the responses of the target object to the execution of multiple items. After the target object 220 completes the response to the target item 230-1, the capability information 222 may be updated in time to accurately reflect the real-time capability of the target object 220.

In some embodiments, in addition to the capability information 222, the attribute information 232 of the item 230 may also be dynamically updated, including the difficulty, the discrimination, and/or the correct probability in pseudo-guessing (if the attribute of the item can be characterized by these parameters) of the item 230. After the target object 220 completes the response to the target item 230-1, the dynamic updating system 200 may also determine the attribute update amount for the target item 230-1 based on the capability information 222 of the target object 220, the attribute information 232-1 of the target item 230-1, and the response result 224, and update the attribute information 232-1 of the target item 230-1 based on the attribute update amount. The updated attribute information 232-1 may be recorded and applied to the next update or to the prediction of the response result for the item.

Since each item 230 may be provided to multiple objects for response, in some embodiments, the attribute information 232-1 of the target item 230-1 may be iteratively updated with the response of multiple objects to the execution of the target item. In some embodiments, considering that the attribute information 232 of the item 230, especially the difficulty information, may reflect the inherent nature of the item 230, so after enough iterations, the attribute information may have been equivalently calibrated, and may no longer be updated iteratively.

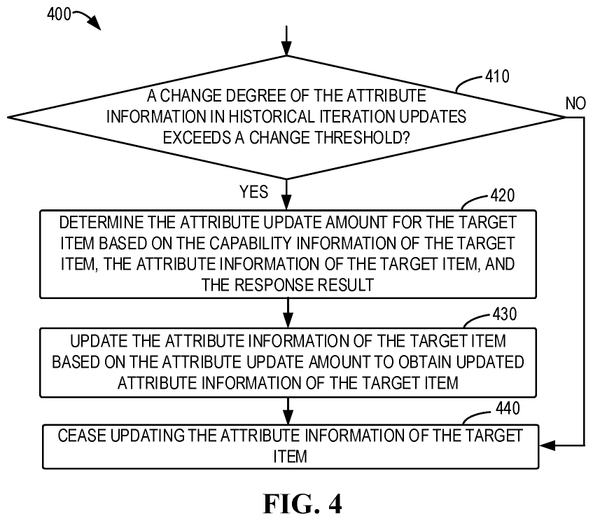

FIG. 4 shows a flowchart of a process 400 of attribute information updating according to some embodiments of the present disclosure. The process 400 may be implemented at the dynamic updating system 200.

Specifically, at block 410, the dynamic updating system 200 determines whether a change degree of the attribute information 232-1 of the target item 230-1 in a plurality of historical iteration updates exceeds a change threshold. In some embodiments, the dynamic updating system 200 may observe the attribute information 232-1 of the target item 230-1 determined in the past two or more historical iterations to determine whether the attribute information 232-1 has an obvious change, for example, whether the attribute update amount determined in each iteration is relatively large. In some embodiments, the change threshold may be set to 0 or a relatively small value, and the specific value can be set according to the actual application.

If it is determined that the change degree of the attribute information 232-1 of the target item 230-1 in multiple historical iterations exceeds the change threshold, it means that the attribute information 232-1 has changed significantly in the past several iterations. In this case, at block 420, the dynamic updating system 200 determines the attribute update amount for the target item 220 based on the capability information 222 of the target item 220, the attribute information 232-1 of the target item 230-1, and the response result 224. At block 430, the dynamic updating system 200 updates the attribute information of the target item based on the attribute update amount to obtain updated attribute information of the target item. The determination of attribute update amount will be discussed in detail below.

If it is determined that the change degree of the attribute information 232-1 of the target item 230-1 in multiple historical iterations does not exceed the change threshold, for example, the attribute information 232-1 fluctuates slightly near a certain value in the past multiple iterations, which means that the attribute information 232-1 has not changed significantly in the past multiple iterations, that is, the attribute information 232-1 may have been equivalently calibrated. In this case, at block 440, the dynamic updating system 200 ceases updating the attribute information 232-1 of the target item 230-1. In this way, if the target item 230-1 continues to be provided to other objects for response, the attribute information 232-1 may also no longer be updated, but the capability information of the object may be updated.

In some embodiments, as mentioned above, the capability information 222 may include overall capability information and local capability information at the measurement branch at different hierarchical levels in the item hierarchy. In the dynamic updating process, the overall capability information may be updated continuously with the response of the target object 220 to each item 230. Since each item 230 may involve the examination of some measurement branches at one or more hierarchical levels in the item hierarchy, the local capability information on the measurement branch involved in the target item 230-1 may accordingly be updated after the completion of the target item 230-1.

As described above, the capability information 222 and the attribute information 232 may be represented by a normal distribution. For the purpose of discussion, it is assumed that the overall capability of the target object 220 (expressed as θ), the local capability at the measurement branch of the first hierarchical level (expressed as γ₁) and the local capability at the measurement branch of the second hierarchical level (expressed as γ₂) are considered, and the difficulty attribute of the item 230 (shown as β) is also considered. In addition, it is also assumed that the target item 230-1 may investigate one measurement branch of the first hierarchical level and n measurement branches of the second hierarchical level. For example, a test question may consider the knowledge point at the first hierarchical level and several branch knowledge points under the knowledge point.

Under the above assumptions, the normal distribution of the capability information 222 and the attribute information 232 may be expressed as follows:

θ˜N(μ_{θ}, σ_{θ}), γ₁˜N(μ_{γ}_{₁},σ_{γ}_{₁}), γ₂ⁱ˜N(μ_{γ}_{₂}ⁱ, σ_{γ}_{₂}ⁱσ_{γ}_{₂}ⁱ),β˜N(μ_{β},σ_{β}),β˜N(μ_{β},σ_{β}) (4)

where the overall capability ƒ follows a normal distribution of an expectation μ_{θ} and a standard deviation δ₇₄ ; the local capability γ₁ at the measurement branch at the first hierarchical level follows a normal distribution of an expectation μ_{γ}_{₁} and a standard deviation δ_{γ}_{₁}; the local capability γ₂ⁱ on the i^{th} measurement branch in the second hierarchical level follows a normal distribution of an expectation μ_{γ}_{₂}ⁱ and a standard deviation δ_{γ}_{₂}ⁱ ; the difficulty β follows a normal distribution of an expectation μ_{β} and a standard deviation δ_{β}.

In some embodiments, assuming that the overall capability (θ) of the target object 220, the local capability on the measurement branch (γ₁) of the first hierarchical level and the local capability (γ₂¹, . . . γ₂ⁿ) on the n measurement branches of the second hierarchical level are considered, and when the single parameter (β) of the difficulty of the item is considered, the two-factor IRT model may be expressed as follows:

$$p ( x = 1 \vert θ , β , {γ}_{1} , {γ}_{2}^{1} , … , {γ}_{2}^{n} ) = Φ ( θ + {γ}_{1} + \frac{{\sum }_{i}^{n} {γ}_{2}^{i}}{n} - β ) \qquad ( 5 )$$

where p represents the probability that the object will make a successful response to the item (that is, x=1).

By accurately estimating the capability information 222 of the target object 220 and the attribute information 232 of the item 230, the two-factor IRT model may be used to more accurately estimate the probability of the successful or failure response of the target object 220 to a specific item.

An example embodiment of iteratively updating for the capability information 222 and the attribute information 232 will be discussed in detail below. In some embodiments, the update of the capability information 222 and/or the attribute information 232 includes updating the expectation and the standard deviation in the corresponding probability distribution (for example, normal distribution).

In some embodiments, in the first iteration of the iteratively updating process, the capability information 222 of the target object 220 may be initialized. In some embodiments, the expectation of the normal distribution of the overall capability information in the capability information 222 may be initialized to 0. In some embodiments, the standard deviation of the normal distribution followed by the overall capability information may be initialized to 1. For example, the overall capability information may be initialized to follow the normal distribution of μ_{θ}=0,σ_{g}=1.

In some embodiments, the expectation of the normal distribution followed by the local capability information at different measurement branches may be initialized to 0. In some embodiments, the standard deviation of the normal distribution of the local capability information at different measurement branches may be initialized to a value between 0 and 1, which can be set according to an application scenario.

In some embodiments, during initialization, the initial standard deviation (or variance) of the local capability may be set to be smaller for the deeper measurement branches (for example, the knowledge point). For example, it is assumed that the capability information of the target object 220 includes at least the first local capability information of the target object 220 at the measurement branch at the first hierarchical level in the item hierarchy and the second local capability information at the measurement branch at the second hierarchical level. Assuming that the first local capability information is initialized as a probability distribution with the first standard deviation, and the second local capability information is initialized as a probability distribution with the second standard deviation, and the second hierarchical level is lower than the first hierarchical level (that is, the second hierarchical level is a deeper hierarchical level), then the second standard deviation may be set to be less than the first standard deviation. As an example, the local capability information of the testee at a first-level knowledge point may be initialized as a normal distribution followed by μ_{γ}_{₁}=0, σ_{γ}_{₁}=X, and the local capability at the second-level knowledge point may be initialized as a normal distribution followed by μ_{γ}_{₂}=0, σ_{γ}_{₂}=Y, where Y may be less than X.

In some application scenarios, it is advantageous to set the deeper measurement branch to have a relatively small standard deviation. The reason is that the deeper the measurement branch is, the more limited the observation may be provided in a later stage (that is, compared with the measurement branch at the higher hierarchical level, the fewer items involved in the specific measurement branch at the deeper hierarchical level). If the variance is set to a relatively large value, the degree of convergence at a later stage will be smaller, which is not conducive to obtaining more accurate estimates. Certainly, in some other application scenarios, the deeper measurement branch may be set to have a larger standard deviation according to the requirements of the scenario.

In some embodiments, if an item 230 is not responded to by any object, the attribute information 232 of the item 230 may be cold-started to follow the normal distribution with an expectation of 0 and a standard deviation of 1. In some embodiments, for the target item 230-1, if one or more objects have responded to the item in the past, and the attribute information 232-1 has been updated, the initial value of the attribute information 232-1 may be the value after the previous update during the updating based on the target object 220.

During the updating process, depending on the different response results 224 of the target object 220 to the target item 230-1, the dynamic updating system 200 may determine a different capability update amount for the capability information 222, and/or a different attribute update amount for the attribute information 232-1. In other words, if the response result indicates the successful response of the target object 220 to the target item 230-1, the dynamic updating system 200 may determine a first capability update amount for the target object 220, and if the response result indicates the failure response of the target object 220 to the target item 230-1, the dynamic updating system 200 may determine a second capability update amount for the target object 220, wherein the second capability update amount is different from the first capability update amount. The capability update amount may include the update amount of the expectation and/or the standard deviation in the probability distribution.

In some embodiments, in updating of the capability information 222, as the target object 220 makes successful responds to more and more items, the overall capability of the target object 220 will be improved, and the local capability at the measurement branch involved in these items will also be improved. Accordingly, the expectation in the probability distribution that the overall capability information and the local capability information follow individually will rise and the standard deviation will decrease, which means that the estimation of the overall capability and the corresponding local capability of the target object 220 will also be more and more determined.

In some embodiments, in updating of the attribute information 232-1, as more and more objects make successful response or failure response to the target item 230-1, the dynamic updating system 200 may iteratively update the attribute information 232-1 to a value that can more accurately represent the target item 230-1.

In some embodiments, the dynamic updating system 200 may determine the estimation of the update amount for the capability information 222 and the attribute information 232 based on the maximum likelihood estimation and other methods. An example estimation method will be given below, but it would be appreciated that other estimation methods may also be applied based on the probability distribution model and the IRT theory of the capability information 222 and the attribute information 232.

In some embodiments, a lower limit value k is set for the variance (that is, the square of the standard deviation) during the updating process to avoid calculating the standard deviation as 0 during the updating process, resulting in calculation errors.

In the following, it is assumed that the capability information 222 of the target object 220 and the attribute information 232-1 of the target item 230-1 are updated in an m^{th} iteration, and that the target item 230-1 involves the local capability at the measurement branch (γ₁) of the first hierarchical level and the local capability (γ₂¹, . . . γ₂ⁿ) at the n measurement branches of the second hierarchical level, and the difficulty parameter (β) of the target item 230 is being considered to update.

When determining the capability update amount and the attribute update amount, the dynamic updating system 200 may determine the following general intermediate variables:

$${v}^{+} ( m ) = \sqrt{1 + {σ}_{β}^{2} ( m ) + {σ}_{θ}^{2} ( m ) + {σ}_{{γ}_{1}}^{2} ( m ) + {\sum }_{i}^{n} {( 1 / n )}^{2} {σ}_{{γ}_{2}^{i}}^{2} ( m )} \qquad ( 6 )$$

$${x}^{*} ( m ) = \frac{{μ}_{θ} ( m ) - {μ}_{β} ( m ) + {μ}_{{γ}_{1}} ( m ) + {\sum }_{i}^{n} ( 1 / n ) {μ}_{{γ}_{i}} ( m )}{{v}^{+} ( m )} \qquad ( 7 )$$

$${Ω}_{0} = \frac{∅ ( {x}^{*} ( m ) )}{1 - Φ ( {x}^{*} ( m ) )} , {Ω}_{1} = \frac{∅ ( {x}^{*} ( m ) )}{Φ ( {x}^{*} ( m ) )} \qquad ( 8 )$$

$${δ}_{θ}^{2} = \frac{{σ}_{θ}^{2} ( m )}{{v}^{2} ( m )} , {δ}_{β}^{2} = \frac{{σ}_{β}^{2} ( m )}{{v}^{2} ( m )} , {δ}_{{γ}_{1}}^{2} = \frac{{σ}_{{γ}_{1}}^{2} ( m )}{{v}^{2} ( m )} , {δ}_{{γ}_{2}^{i}}^{2 +} = \frac{{σ}_{{γ}_{2}^{i}}^{2} ( m )}{{n}^{2} {v}^{2 +} ( m )} \qquad ( 9 )$$

In some embodiments, in updating of the overall capability information in the capability information 222, if the response result 224 indicates the successful response of the target object 220 to the target item 230-1, the dynamic updating system 200 may update the expectation and variance of the probability distribution that the overall capability information follows as follows:

$${μ}_{θ} ( m + 1 ) = {μ}_{θ} ( m ) + \frac{{σ}_{θ}^{2}}{v ( m )} {Ω}_{1} \\ {σ}_{θ}^{2} ( m + 1 ) = {σ}_{θ}^{2} ( m ) max ( 1 - {δ}_{θ}^{2} ( {x}^{*} ( m ) {Ω}_{1} + {Ω}_{1}^{2} ) , k ) \qquad ( 10 A )$$

where the expected update amount

$$\frac{{σ}_{θ}^{2}}{v ( m )} {Ω}_{1}$$

is added to the current expectation μ_{θ}(m), and the current variance σ_{θ}²(m) is weighted and updated by the weight calculated from max (1−δ_{θ}²(x*(m)Ω₁+Ω₁²), k).

In some embodiments, if the response result 224 indicates the failure response of the target object 220 to the target item 230-1, the dynamic updating system 200 may update the expectation and the variance of the probability distribution that the overall capability information follows as follows:

$${μ}_{θ} ( m + 1 ) = {μ}_{θ} ( m ) - \frac{{σ}_{θ}^{2}}{v ( m )} {Ω}_{0} \\ {σ}_{θ}^{2} ( m + 1 ) = {σ}_{θ}^{2} ( m ) max ( 1 - {δ}_{θ}^{2} ( - {x}^{*} ( m ) {Ω}_{0} + {Ω}_{0}^{2} ) , k ) \qquad ( 10 B )$$

where the expected update amount

$$- \frac{{σ}_{θ}^{2}}{v ( m )} {Ω}_{0}$$

is added to the current expectation μ_{g}(m) to reduce the current expectation. The current variance σ_{θ}²(m) is weighted and updated by the weight calculated from max(1−δ_{θ}²(−x*(m)Ω₀+Ω₀²), k).

In some embodiments, the update of the local capability information at the measurement branch at the first hierarchical level and the measurement branch at the second hierarchical level in the capability information 222 is similar to the update of the overall capability information. For example, when the response result 224 indicates the successful response of the target object 220 to the target item 230-1, the dynamic updating system 200 may update the expectation and the variance of the probability distribution that the local capability information at the measurement branch at the first hierarchical level as follows:

$${μ}_{{γ}_{1}} ( m + 1 ) = μ ( m ) + \frac{{σ}_{{γ}_{1}}^{2}}{v ( m )} {Ω}_{1} \\ {σ}_{{γ}_{1}}^{2} ( m + 1 ) = {σ}_{{γ}_{1}}^{2} ( m ) max ( 1 {δ}_{{γ}_{1}}^{2} ( {x}^{*} ( m ) {Ω}_{1} + {Ω}_{1}^{2} ) , k ) \qquad ( 11 A )$$

If the response result 224 indicates the failure response of the target object 220 to the target item 230-1, the dynamic updating system 200 may update the expectation and the variance of the probability distribution of the local capability information at the measurement branch at the first hierarchical level as follows:

$${μ}_{{γ}_{1}} ( m + 1 ) = {μ}_{{γ}_{1}} ( m ) - \frac{{σ}_{{γ}_{1}}^{2}}{v ( m )} {Ω}_{0} \\ {σ}_{{γ}_{1}}^{2} ( m + 1 ) = {σ}_{{γ}_{1}}^{2} ( m ) max ( 1 - {δ}_{{γ}_{1}}^{2} ( - {x}^{*} ( m ) {Ω}_{0} + {Ω}_{0}^{2} ) , k ) \qquad ( 11 B )$$

In some embodiments, when the response result 224 indicates the successful response of the target object 220 to the target item 230-1, the dynamic updating system 200 may update the expectation and the variance of the probability distribution of the local capability information at the i^{th} measurement branch at the second hierarchical level as follows:

$${μ}_{{γ}_{2}^{i}} ( m + 1 ) = {μ}_{{γ}_{2}^{i}} ( m ) + \frac{{σ}_{{γ}_{2}^{i}}^{2}}{nv ( m )} {Ω}_{1} \\ {σ}_{{γ}_{2}^{i}}^{2} ( m + 1 ) = {σ}_{{γ}_{2}^{i}}^{2} ( m ) max ( 1 - {δ}_{{γ}_{2}^{i}}^{2} ( {x}^{*} ( m ) {Ω}_{1} + {Ω}_{1}^{2} ) , k ) \qquad ( 12 A )$$

When the response result 224 indicates the successful response of the target object 220 to the target item 230-1, the dynamic updating system 200 may update the expectation and the variance of the probability distribution of the local capability information at the i^{th} measurement branch at the second hierarchical level as follows:

$${μ}_{{γ}_{2}^{i}} ( m + 1 ) = {μ}_{{γ}_{2}^{i}} ( m ) - \frac{{σ}_{{γ}_{2}^{i}}^{2}}{nv ( m )} {Ω}_{0} \\ {σ}_{{γ}_{2}^{i}}^{2} ( m + 1 ) = {σ}_{{γ}_{2}^{i}}^{2} ( m ) max ( 1 - {δ}_{{γ}_{2}^{i}}^{2} ( - {x}^{*} ( m ) {Ω}_{0} + {Ω}_{0}^{2} ) , k ) \qquad ( 12 B )$$

In some embodiments, in updating of the difficulty information in the attribute information 232-1 of the target item 230-1, if the response result 224 indicates the failure response of the target object 220 to the target item 230-1, the dynamic updating system 200 may update the expectation and the variance of the probability distribution that the difficulty information follows as follows:

$${μ}_{β} ( m + 1 ) = {μ}_{β} ( m ) + \frac{{σ}_{β}^{2}}{v ( m )} {Ω}_{0} \\ {σ}_{β}^{2} ( m + 1 ) = {σ}_{β}^{2} ( m ) max ( 1 - {δ}_{β}^{2} ( - {x}^{*} ( m ) {Ω}_{0} + {Ω}_{0}^{2} ) , k ) \qquad ( 13 A )$$

where the expected update amount

$$\frac{{σ}_{β}^{2}}{v ( m )} {Ω}_{0}$$

is added to the current expectation μ_{β}(m). The current variance σ_{β}²(m) is weighted and updated by the weight calculated from max(−δ_{β}²(=x*(m)Ω₀+Ω₀²), k).

In some embodiments, if the response result 224 indicates the successful response of the target object 220 to the target item 230-1, the dynamic updating system 200 can update the expectation and variance of the probability distribution that the difficulty information follows as follows:

$${μ}_{β} ( m + 1 ) = {μ}_{β} ( m ) - \frac{{σ}_{β}^{2}}{v ( m )} {Ω}_{1} \\ {σ}_{β}^{2} ( m + 1 ) = {σ}_{β}^{2} ( m ) max ( 1 - {δ}_{β}^{2} ( {x}^{*} ( m ) {Ω}_{1} + {Ω}_{1}^{2} ) , k ) \qquad ( 13 B )$$

where the expected update amount

$$- \frac{{σ}_{β}^{2}}{v ( m )} {Ω}_{1}$$

is added to the current expectation μ_{β}(m). The current variance σ_{β}²(m) is weighted and updated by the weight calculated from max(1−δ_{β}²(x*(m)Ω₁+Ω₁²), k.

Although the update of the difficulty information of the item is given above, for other attribute parameters, such as the discrimination and the correct probability in pseudo-guessing, the corresponding update amount may also be determined and updated based on the IRT theory.

According to the above update, a latest capability information of the target object 220 after completing the current target item 230-1 may be determined. In some embodiments, the attribute information 232-1 of the target item 230-1 may also be more accurately estimated by updating the attribute information.

In some embodiments, the capability information 222 may be further updated by continuously providing the item 230 to the target object 220 for response. In addition, the target item 230-1 may also be provided to more objects for response, to further update the attribute information 232-1.

The accurate estimation of the capability information 222 of the target object 220 and the attribute information 232 of each item 230 may be applied to various application scenarios of the IRT theory. By accurately understanding the capability information of the target object, it is helpful to push the item to the target object. In addition, in the two-factor IRT model, understanding the overall and local capability information of the target object may help to determine the comprehensive capability of the target object and whether the local capability is insufficient at a measurement branch, to formulate a follow-up strategy. Further, after understanding the capability information of a target group, it may also be used for the target group to specify the follow-up strategy, a target object classification strategy, an education strategy, a test strategy, and the like.

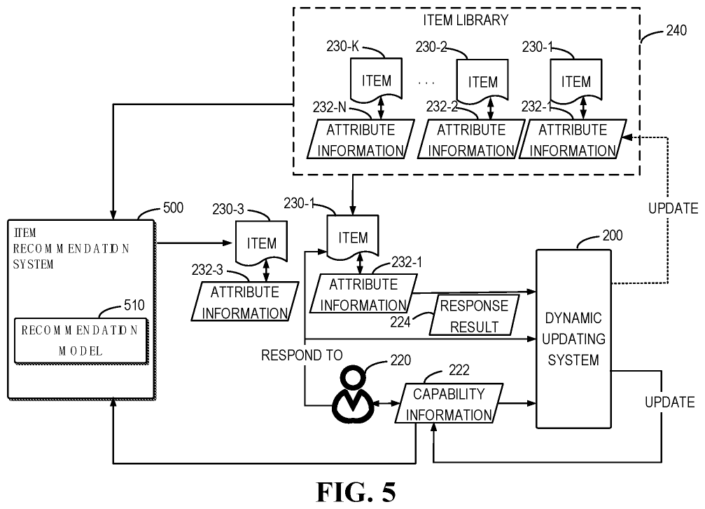

FIG. 5 shows a schematic diagram of the application of the dynamic updating system 200 according to some embodiments of the present disclosure. In this example, the capability information 222 of the object and the attribute information 232 of the item 230 dynamically updated by the dynamic updating system 220 may be provided to an item recommendation system 500, which is configured to use a predetermined recommendation model 510 to perform an item recommendation task for the target object 220.

In some embodiments, the recommendation model 510 may be constructed based on a machine learning model or a deep learning model (for example, a neural network model), or the IRT model (for example, the IRT model 110 of FIG. 1). In some embodiments, the input of the recommendation model 510 may at least include the updated capability information 222 of the target object 220 and the attribute information 232 of the item in the item library 240. In the case that the recommendation model 510 is constructed based on a machine learning or deep learning model, in some embodiments, the input of the recommendation model 510 may also include other relevant information of the target object 220, other relevant information of the item 230, and/or any other information considered to affect the recommendation of the item of the target object 220. This may be configured according to the actual application.

Specifically, the item recommendation system 500 may use the recommendation model 510 to determine the predicted response result of the target object 220 to the other target item 230 based on at least the updated capability information 222 of the target object 220 and the attribute information 232 of the other target item 230 in the item library 240. The predicted response result may indicate the probability of the successful response or the probability of the failure response of the target object 220 to another target item 230.

In some embodiments, the recommendation model 510 may determine the predicted response result based on at least the above equation (5). In determining the predicted response result, based on the measurement branch involved in another target item 230, the overall capability information of the target object 220 and the local capability information at the corresponding measurement branch are used as the input of the recommendation model 510.

In some embodiments, when determining the predicted response result, the item recommendation system 500 may also consider the weight of the local capability information at different measurement branches at the item hierarchy. Specifically, in a hierarchy with multiple measurement branches, different measurement branches may have corresponding weights. The item recommendation system 500 obtains the weight value for one or more measurement branches in one or more hierarchical levels, and weights the local capability information at the corresponding measurement branches based on the weight value of each measurement branch, to obtain the weighted local capability information. The recommendation model 510 may determine the predicted response result based on the weighted local capability information and the overall capability information and the attribute information of the item 230.

In some embodiments, the item hierarchy includes the measurement branch at the first hierarchical level and the second hierarchical level, and a certain item 230 to be predicted involves n measurement branches at the second hierarchical level. In an embodiment that considers weighting local capability information, the recommendation model 510 may be expressed as follows:

$$p ( x = 1 \vert θ , β , {γ}_{1} , {γ}_{2}^{1} , … {γ}_{2}^{n} ) = Φ ( θ + {γ}_{1} + \frac{{\sum }_{i}^{n} {weight}_{i} {γ}_{2}^{i}}{{\sum }_{i}^{n} {weight}_{i}} - β ) \qquad ( 14 )$$

where weightᵢ represents the weight value for the i^{th} measurement branch of the second hierarchical level. In this example, it is assumed that the local capability information at the measurement branch of the first hierarchical level is not weighted.

By setting the weight value for the local capability information, the difference between different measurement branches in a capability assessment may be effectively weighed when measuring the capability information of the target object 220. In some embodiments, at the same hierarchical level, the measurement branch that may make greater contributions to the successful response may be set with a greater weight value. In other embodiments, the weight value of the measurement branch may be set after considering any other factors according to the actual application.

Although the above description is made for the embodiment of the item hierarchy involving two hierarchical levels, the item hierarchy may involve three or more hierarchical levels. In such an embodiment, for a third hierarchical level, the weight value for the measurement branch may also be set, and the weight value is weighted to the corresponding local capability information when determining the predicted response result. For example, it is assumed that the item hierarchy includes the measurement branch at the first hierarchical level, the second hierarchical level and the third hierarchical level, and an item 230 to be predicted involves n measurement branches at the second hierarchical level and M measurement branches at the third hierarchical level. In an embodiment that considers weighting the local capability information, the recommendation model 510 may be expressed as follows:

$$p ( x = 1 \vert θ , β , {γ}_{1} , {γ}_{2}^{1} , … {γ}_{2}^{n} , {γ}_{3}^{1} , … {γ}_{3}^{M} ) = Φ ( θ + {γ}_{1} + \frac{{\sum }_{i}^{n} {weight}_{i} {γ}_{2}^{i}}{{\sum }_{i}^{n} {weight}_{i}} + \frac{{\sum }_{i}^{M} {weight}_{i} {γ}_{3}^{i}}{{\sum }_{i}^{M} {weight}_{i}} - β ) \qquad ( 15 )$$

where γ₃¹, . . . γ₃^{M} represent the local capability information of the target object 220 at each of the M measurement branches at the third hierarchical level, and the local capability information at each measurement branch at the third hierarchical level is also weighted by the corresponding weight value. Note that the weight values used to weight the local capability information at the measurement branch at the second hierarchical level and the measurement at the third hierarchical level may be set individually.

In some embodiments, in addition to the shown target object 220, the IRT model 220 may also be used to determine the predicted response result of other objects to each item 230 in the item library 240, including the predicted response result of the item 230-1.

In some embodiments, based on the predicted response result, the item recommendation system 500 or the recommendation model 510 may further implement various recommendation strategies for the item 230 and/or the target object 220. For example, in some embodiments, the item recommendation system 500 may recommend items to be responded to later (such as the test question to be answered later) to the target object 220, such as the item 230-3. The item recommendation system 500 may recommend items to the target object 220 according to different item recommendation strategies based on the predicted response result.

In some embodiments, the item recommendation system 500 may not calculate the predicted response result, but directly analyze the capability information 222 of the target object 220 to recommend the items to be responded to later, such as the test question to be answered later.

In some examples, as the target object 220 completes the response to the item 230-3, the response result, the attribute information 232-3 of the item 230-3, and the current capability information 222 of the target object 220 may also be provided to the dynamic updating system 200 for further updating the capability information 222 and/or the attribute information 232-3. Details are not described herein again.

Certainly, as mentioned above, in addition to the item recommendation, the capability information 222 of the target object 220 and the attribute information 232 of the item 230 may also be applied in other tasks. The embodiments of the present disclosure are not limited in this regard.

In some embodiments, the dynamic updating system 200 and/or the item recommendation system 500 may be implemented at a terminal device or server. The terminal device may be any type of mobile terminals, fixed terminals or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital/video camera, a positioning device, a TV receiver, a radio broadcast receiver, an e-book device, a game device or any combination of the foregoing, including accessories and peripherals of these devices or any combination thereof. In some embodiments, the terminal device can also support any type of user-specific interfaces (such as a “wearable” circuit, etc.). Servers are various types of computing systems/servers that can provide computing power, including but not limited to mainframes, edge computing nodes, computing devices in cloud environments, etc.

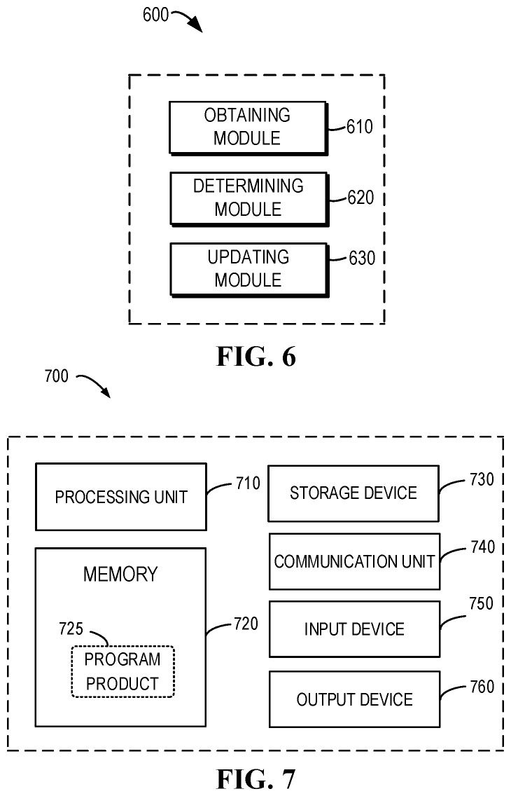

FIG. 6 shows a schematic block diagram of an apparatus 600 for information updating according to some embodiments of the present disclosure. The apparatus 600 may be implemented or included in the dynamic updating system 200 and/or the item recommendation system 500. Each module/component in the apparatus 600 may be implemented by a hardware, a software, a firmware, or any combination thereof.

As shown in the figure, the apparatus 600 includes an obtaining module 610, which is configured to obtain the response result of the target object to the target item, and the response result indicates the successful or the failure response of the target object to the target item. The apparatus 600 also includes a determining module 620, which is configured to determine the capability update amount for the target object based on the capability information of the target object, and the attribute information of the target item, and the response result. The apparatus 600 further includes an updating module 630, which is configured to update the capability information of the target object based on the capability update amount to obtain the updated capability information of the target object.

In some embodiments, the capability information of the target object may include at least one of the following: the overall capability information of the target object, which indicates the overall capability level of the target object among a plurality of measurement branches at a plurality of hierarchical levels in the item hierarchy, and the local capability information of the target object at at least one measurement branch at at least one hierarchical level in the item hierarchy. The target item relates to the examination of the at least one measurement branch.

In some embodiments, the overall capability information may indicate the probability distribution by which the overall capability level of the target object is followed. In some embodiments, the local capability information on each of the at least one measurement branch may indicate the probability distribution followed by a local capability level of the target object on the measurement branch.

In some embodiments, the capability information of the target object may be updated iteratively with responses of a plurality of items executed by the target object, and the capability information of the target object may be initialized in the first iteration.

In some embodiments, the capability information of the target object may include at least the first local capability information of the target object at the measurement branch at the first hierarchical level in the item hierarchy and the second local capability information at the measurement branch at the second hierarchical level. In some embodiments, the first local capability information may be initialized as a probability distribution with the first standard deviation, and the second local capability information may be initialized as a probability distribution with the second standard deviation. The second hierarchical level is lower than the first hierarchical level, and the second standard deviation may be lower than the first standard deviation.

In some embodiments, the determining module 620 may include: a first update determining module configured to determine the first capability update amount for the target object when the response result indicates the successful response of the target object to the target item; and a second update determining module configured to determine the second capability update amount for the target object when the response result indicates the failure response of the target object to the target item. The second capability update amount is different from the first capability update amount.

In some embodiments, the apparatus 600 may also include: an attribute update determining module configured to determine the attribute update amount for the target item based on the capability information of the target object, the attribute information of the target item and the response result; and an attribute updating module configured to update the attribute information of the target item based on the attribute update amount to obtain the updated attribute information of the target item.

In some embodiments, the attribute information of the target item may be updated iteratively with the responses of the target item executed by a plurality of objects. In some embodiments, the attribute update determining module may include: a change determining module configured to determine whether the change degree of the attribute information of the target item in a plurality of historical iteration updates exceeds the change threshold; and a change-based updating module configured to determine the attribute update amount for the target item when the change degree of the attribute information of the target item in a plurality of historical iteration updates exceeds the change threshold.

In some embodiments, the apparatus 600 may also include: a first predicting module configured to determine the predicted response result of a further target object to the target item based on the updated attribute information of the target item and the capability information of the further target object using a predetermined item response theory model.

In some embodiments, the apparatus 600 may also include a second predicting module configured to determine the predicted response result of the target object to a further target item based on the updated capability information of the target object and the attribute information of the further target item using a predetermined item response theoretical model.

In some embodiments, the capability information of the target object may include: the overall capability information of the target object and the local capability information of the target object at at least one further measurement branch of at least one hierarchical level in the item hierarchy, and the further item relates to at least one further measurement branch. In some embodiments, the second predicting module may include: a weight obtaining module, which is configured to obtain a respective weight values for the at least one further measurement branch; weighting module configured to weight the local capability information at the at least one measurement branch based on the respective weight value of the at least one further measurement branch to obtain the weighted local capability information; and a weighted predicting module configured to determine the predicted response result of the target object to the further target item based on the overall capability information, the weighted local capability information and the attribute information of the further target item using the item response theory model.

In some embodiments, the target item may include a test question, and the target object may include a testee who answers the test question. In some embodiments, the target item may include the recommendation item, and the target object may include the recommended object. In some embodiments, the target item may include a competitor, and the target object may include a participating team or a team member.

In some embodiments, the attribute information of the target item indicates at least one of the following: the difficulty of the target item, the discrimination of the target item, and the correct probability in pseudo-guessing of the target item.

FIG. 7 shows a block diagram of a computing device/system 700 in which one or more embodiments of the present disclosure may be implemented. It would be appreciated that the computing device/system 700 shown in FIG. 7 is only an example and should not constitute any restriction on the function and scope of the embodiments described herein. The computing device/system 700 shown in FIG. 7 may be used to implement the dynamic updating system 200 of FIG. 2 and/or the item recommendation system 500 of FIG. 5.

As shown in FIG. 7, the computing device/system 700 is in the form of a general computing device. The components of the computing device/system 700 may include, but are not limited to, one or more processors or processing units 710, a memory 720, a storage device 730, one or more communication units 740, one or more input devices 750, and one or more output devices 760. The processing unit 710 may be an actual or virtual processor and can execute various processes according to the programs stored in the memory 720. In a multiprocessor system, multiple processing units execute computer executable instructions in parallel to improve the parallel processing capability of the computing device/system 700.

The computing device/system 700 typically includes a variety of computer storage medium. Such medium may be any available medium that is accessible to the computing device/system 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 730 may be any removable or non-removable medium, and may include a machine-readable medium, such as a flash drive, a disk, or any other medium, which can be used to store information and/or data (such as training data for training) and can be accessed within the computing device/system 700.

The computing device/system 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 communicates with a further computing device through the communication medium. In addition, functions of components in the computing device/system 700 may be implemented by a single computing cluster or multiple computing machines, which can communicate through a communication connection. Therefore, the computing device/system 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The computing device/system 700 may also communicate with one or more external devices (not shown) through the communication unit 740 as required. The external device, such as a storage device, a display device, etc., communicate with one or more devices that enable users to interact with the computing device/system 700, or communicate with any device (for example, a network card, a modem, etc.) that makes the computing device/system 700 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above.

According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for information updating, comprising:
obtaining a response result of a target object to a target item, the response result indicating a successful response or a failure response of the target object to the target item;
determining a capability update amount for the target object based on capability information of the target object, attribute information of the target item, and the response result; and
updating the capability information of the target object based on the capability update amount, to obtain updated capability information of the target object.

2. The method of claim 1, wherein the capability information of the target object comprises at least one of the following:
overall capability information of the target object indicating an overall capability level of the target object among a plurality of measurement branches at a plurality of hierarchical levels in an item hierarchy, and
local capability information of the target object at at least one measurement branch at at least one hierarchical level in the item hierarchy, the target item being related to examination of the at least one measurement branch.

3. The method of claim 2, wherein the overall capability information indicates a probability distribution followed by the overall capability level of the target object, and
wherein the local capability information on each of the at least one measurement branch indicates a probability distribution followed by a local capability level of the target object on the measurement branch.

4. The method of claim 2, wherein the capability information of the target object is iteratively updated with responses of a plurality of items executed by the target object, and the capability information of the target object is initialized in the first iteration.

5. The method of claim 1, wherein determining the capability update amount for the target object comprises:
in accordance with a determination that the response result indicates the successful response of the target object to the target item, determining a first capability update amount for the target object; and
in accordance with a determination that the response result indicates the failure response of the target object to the target item, determining a second capability update amount for the target object, the second capability update amount being different from the first capability update amount.

6. The method of claim 1, further comprising:
determining an attribute update amount for the target item based on the capability information of the target object, the attribute information of the target item, and the response result; and
updating the attribute information of the target item based on the attribute update amount, to obtain updated attribute information of the target item.

7. The method of claim 6, wherein the attribute information of the target item is iteratively updated with the responses of the target item executed by a plurality of objects, and determining the attribute update amount for the target item comprises:
determining whether a change degree of the attribute information of the target item in a plurality of historical iteration updates exceeds a change threshold; and
in accordance with a determination that the change degree of the attribute information of the target item in the plurality of historical iteration updates exceeds the change threshold, determining the attribute update amount for the target item.

8. The method of claim 6, further comprising:
determining, using a predetermined item response theory model, a predicted response result of a further target object to the target item based on the updated attribute information of the target item and capability information of the further target object.

9. The method of claim 1, further comprising:
determining, using a predetermined item response theory model, a predicted response result of the target object to a further target item based on the updated capability information of the target object and attribute information of the further target item.

10. The method of claim 9, wherein the capability information of the target object comprises: overall capability information of the target object and local capability information of the target object at least one further measurement branch of at least one hierarchical level in an item hierarchy, the further item being related to the at least one further measurement branch, and
wherein determining the predicted response result comprises:
obtaining a respective weight value for the at least one further measurement branch;
weighting the local capability information at the at least one measurement branch based on the respective weight value of the at least one further measurement branch, to obtain the weighted local capability information; and
determining, using the item response theory model, the predicted response result of the target object to the further target item based on the overall capability information, the weighted local capability information, and the attribute information of the further target item.

11. The method of claim 1, wherein the target item comprises a test question, and the target object comprises a testee who answers the test question; or
wherein the target item comprises a recommendation item, and the target object comprises a recommended object; or
wherein the target item comprises a competitor, and the target object comprises a participating team or a team member.

12. The method of claim 1, wherein the attribute information of the target item indicates at least one of the following: a difficulty of the target item, a discrimination of the target item, and a correct probability in pseudo-guessing of the target item.

13. An electronic device, comprising:
at least one processing unit; and
at least one memory coupled to the at least one processing unit and storing instructions executable by the at least one processing unit, the instructions, when executed by the at least one processing unit, causing the device to
obtain a response result of a target object to a target item, wherein the response result indicates a successful response or a failure response of the target object to the target item;
determine a capability update amount for the target object based on the capability information of the target object, wherein the attribute information of the target item and the response result; and
update the capability information of the target object based on the capability update amount, to obtain updated capability information of the target object.

14. The device of claim 13, wherein the capability information of the target object comprises at least one of the following:
overall capability information of the target object indicating an overall capability level of the target object among a plurality of measurement branches at a plurality of hierarchical levels in an item hierarchy, or
local capability information of the target object at at least one measurement branch at at least one hierarchical level in the item hierarchy, the target item being related to examination of the at least one measurement branch.

15. The device of claim 14, wherein the overall capability information indicates a probability
distribution followed by the overall capability level of the target object, and wherein the local capability information on each of the at least one measurement branch indicates a probability distribution followed by a local capability level of the target object on the measurement branch.

16. The device of claim 14, wherein the capability information of the target object is iteratively updated with responses of a plurality of items executed by the target object, and the capability information of the target object is initialized in the first iteration.

17. The device of claim 14, wherein the instructions, when executed by the at least one processing unit, further cause the device to:
determine an attribute update amount for the target item based on the capability information of the target object, the attribute information of the target item, and the response result; and
update the attribute information of the target item based on the attribute update amount, to obtain updated attribute information of the target item.

18. The device of claim 17, wherein the attribute information of the target item is iteratively updated with the responses of the target item executed by a plurality of objects, and wherein the instructions, when executed by the at least one processing unit, cause the device to:
determine whether a change degree of the attribute information of the target item in a plurality of historical iteration updates exceeds a change threshold; and
determine the attribute update amount for the target item in accordance with a determination that the change degree of the attribute information of the target item in a plurality of historical iteration updates exceeds the change threshold.

19. The device of claim 17, wherein the instructions, when executed by the at least one processing unit, further cause the device to:
determine, using a predetermined item response theory model, a predicted response result of a further target object to the target item based on the updated attribute information of the target item and capability information of the further target object.

20. A non-volatile computer-readable storage medium having a computer program stored thereon which, when executed by a processor, performs acts comprising:
obtaining a response result of a target object to a target item, the response result indicating a successful response or a failure response of the target object to the target item;
determining a capability update amount for the target object based on capability information of the target object, attribute information of the target item, and the response result; and
updating the capability information of the target object based on the capability update amount, to obtain updated capability information of the target object.
